(19) United States
(12) Patent Application Publication
(10) Pub. No.: US 2024/0153265 A1
(43) Pub. Date: May 9, 2024

(54) ROAD DATA PROCESSING METHOD, DEVICE, AND STORAGE MEDIUM

(71) Applicant: BEIJING BAIDU NETCOM SCIENCE TECHNOLOGY CO., LTD., BEIJING (CN)

(72) Inventors: Houkai LIU, BEIJING (CN); Zhenan LI, BEIJING (CN); Tianyu ZHANG, BEIJING (CN); Xiliang DENG, BEIJING (CN); Bing JIANG, BEIJING (CN)

(21) Appl. No.: 17/775,606

(22) PCT Filed: Nov. 10, 2021
(86) PCT No.: PCT/CN2021/129886

§ 371 Date: May 10, 2022

(30) Foreign Application Priority Data
Apr. 28, 2021 (CN) 202110470264.3

(51) Int. Cl. G06V 20/10; G06V 10/25; G06V 20/56

(52) U.S. Cl. CPC G06V 20/182; G06V 10/25; G06V 20/588; G06T 2207/30256

(57) ABSTRACT

A road data processing method, a device, and a storage medium are provided, and relate to the technical fields of intelligent transportation, cloud computing and spatiotemporal big data. The road data processing method includes: acquiring vehicle travelling trajectories of a road and a corresponding road unit in a road network; establishing a road vertical line for the road unit, and determining points of intersection of the vehicle travelling trajectories and the road vertical line; determining a width area of the road on the road vertical line according to position data of the points of intersection; and determining a midpoint of the width area as a road center point corresponding to the road vertical line.

This application is a National Stage application of PCT international application PCT/CN2021/129886, filed on Nov. 10, 2021, which claims priority to Chinese patent application No. 202110470264.3, titled “ROAD DATA PROCESSING METHOD AND APPARATUS, DEVICE, AND STORAGE MEDIUM” and filed with the China Patent Office on Apr. 28, 2021, both of which are hereby incorporated by reference in their entireties.

### TECHNICAL FIELD

The present disclosure relates to the field of computer technology, and in particular, to the technical fields of intelligent transportation, cloud computing and spatiotemporal big data.

### BACKGROUND

At present, road data processing technologies have been widely used in construction, vehicle information, traffic and other businesses. For example, by comparing and observing the latest changes in road center points or road centerlines, effective construction information can be mined for operations. For another example, the vehicle information modification can be judged by the change of the road center points or the road centerlines.

### SUMMARY

The present disclosure provides a road data processing method and apparatus, a device, and a storage medium.

According to an aspect of the present disclosure, a road data processing method is provided, including:
acquiring vehicle travelling trajectories of a road and a corresponding road unit in a road network;
establishing a road vertical line for the road unit, and determining points of intersection of the vehicle travelling trajectories and the road vertical line;
determining a width area of the road on the road vertical line according to position data of the points of intersection; and
determining a midpoint of the width area as a road center point corresponding to the road vertical line.

According to another aspect of the present disclosure, an electronic device is provided, which includes:
at least one processor; and
a memory communicatively connected with the at least one processor, wherein
the memory stores instructions executable by the at least one processor, and the instructions, when executed by the at least one processor, enable the at least one processor to perform the road data processing method in any one of embodiments of the present disclosure.

According to another aspect of the present disclosure, there is provided a non-transitory computer-readable storage medium storing computer instructions, wherein the computer instructions, when executed by a computer, cause the computer to perform the road data processing method in any one of the embodiments of the present disclosure.

It should be understood that the content described in this section is not intended to limit the key or important features of the embodiments of the present disclosure, and is also not intended to limit the scope of the present disclosure. Other features of the present disclosure will be readily understood through the following description.

### BRIEF DESCRIPTION OF THE DRAWINGS

The drawings are used to better understand the scheme and do not constitute a limitation to the present disclosure, wherein:

FIG. 1 is a flowchart of a road data processing method according to an embodiment of the present disclosure;

FIG. 2 is a schematic diagram of a road network and vehicle travelling trajectories of a road data processing method according to another embodiment of the present disclosure;

FIG. 3 is a schematic flowchart of centerline data calculation of a road data processing method according to another embodiment of the present disclosure;

FIG. 4 is a flowchart of an image processing method according to another embodiment of the present disclosure;

FIG. 5 is a schematic flowchart of centerline data calculation of an image processing method according to another embodiment of the present disclosure;

FIG. 6 is a flowchart of an image processing method according to another embodiment of the present disclosure;

FIG. 7 is a schematic flowchart of centerline data calculation of an image processing method according to another embodiment of the present disclosure;

FIG. 8 is a schematic diagram of an index manager of an image processing method according to another embodiment of the present disclosure;

FIG. 9 is a schematic diagram of a road data processing apparatus according to an embodiment of the present disclosure;

FIG. 10 is a schematic diagram of a road data processing apparatus according to another embodiment of the present disclosure;

FIG. 11 is a schematic diagram of a road data processing apparatus according to another embodiment of the present disclosure;

FIG. 12 is a block diagram of an electronic device for implementing the embodiments of the present disclosure.

### DETAILED DESCRIPTION

Exemplary embodiments of the present disclosure are described below in combination with the drawings, including various details of the embodiments of the present disclosure to facilitate understanding, which should be considered as exemplary only. Thus, those of ordinary skill in the art should realize that various changes and modifications can be made to the embodiments described here without departing from the scope and spirit of the present disclosure. Likewise, descriptions of well-known functions and structures are omitted in the following description for clarity and conciseness.

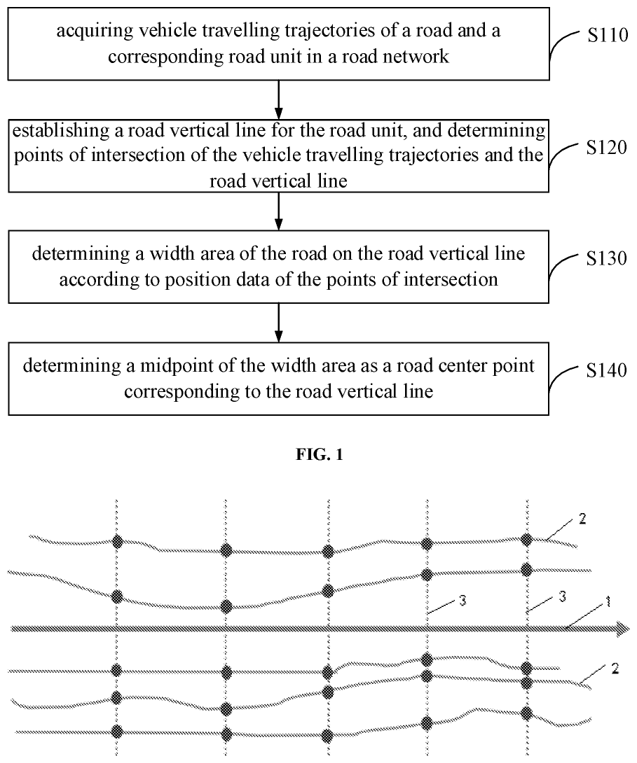

FIG. 1 is a flowchart of a road data processing method according to an embodiment of the present disclosure. Referring to FIG. 1, the road data processing method may specifically include:
S110, acquiring vehicle travelling trajectories of a road and a corresponding road unit in a road network;
S120, establishing a road vertical line for the road unit, and determining points of intersection of the vehicle travelling trajectories and the road vertical line;
S130, determining a width area of the road on the road vertical line according to position data of the points of intersection; and
S140, determining a midpoint of the width area as a road center point corresponding to the road vertical line.

In business scenarios such as construction, vehicle information, and traffic, accurate acquisition of center point data of real roads is helpful for the rapid development of road mining business and helps to improve the recall rate of road data mining business. In addition, the road centerline data can also be obtained according to the road center point data. In the technical fields of intelligent transportation and data mining technology, road centerline portrait is one of the most important basic data of road element mining technology. By comparing and observing the latest changes in the road centerlines, effective construction information can be mined for operation, and the comparing and observing the latest changes in the road centerlines can also be used to judge the vehicle information modification. For example, for a newly opened road, the road center point data and the road centerline data can be acquired through the acquired vehicle travelling trajectories, so as to acquire updated and accurate road data in real time. For another example, in a case where no vehicle travelling trajectory of a certain road can be acquired at the current moment, the center point data and the centerline data of the road cannot be obtained through data mining. In this case, the road may be in a blocking state at the current moment, and the latest state of the road can be updated in time on a map or other application scenarios.

In S110, on the one hand, the vehicle travelling trajectories on a certain road can be acquired in real time. For example, a vehicle travelling trajectory recording device installed on a vehicle side can upload the vehicle travelling trajectories to the server side in real time, and the server side can acquire the vehicle travelling trajectories on each road in real time. On the other hand, each road for vehicle travelling in an actual traffic scene has a corresponding Link (road unit) in a road network. The link is a line segment representing a road in the road network. For example, the Link can represent a straight road on the map, with no bifurcations. While the vehicle travelling trajectories of the road are acquired, the corresponding road unit in the road network can be acquired.

FIG. 2 is a schematic diagram of a road network and vehicle travelling trajectories of a road data processing method according to another embodiment of the present disclosure. In FIG. 2, the line segment with an arrow and numbered 1 represents a Link in the road network; the lines numbered 2 represent several vehicle travelling trajectories in the road corresponding to the Link. In S120, road vertical lines may be established for the Link in the road network. Referring to FIG. 2, vertical lines can be drawn for the line segment numbered 1. The dashed lines numbered 3 in FIG. 2 represent the road vertical lines established for the Link numbered 1. In an example, a series of road vertical lines can be established for each Link in the road network at equal intervals, to segment the Link. After the road vertical lines are established, the positions of the points of intersection of each vehicle travelling trajectory and all road vertical lines can be calculated. The solid circles in FIG. 2 represent the points of intersection of the vehicle travelling trajectories and the road vertical lines.

In S130, the position data of multiple points of intersection on the same road vertical line can be analyzed to determine the width area of the road at the position where the road vertical line is located. In S140, the midpoint of the width area determined in S130 is selected, and the midpoint of the width area is determined as the road center point corresponding to the road vertical line.

In the embodiment of the present disclosure, based on Link data of the road network, a series of road vertical lines are established for each Link, and the points of intersection of the vehicle travelling trajectory and the vertical line is calculated. For a large number of points of intersection of the same road vertical line, the width area of the road is determined according to the positions of the points of intersection, and the midpoint corresponding to the width area of the road is considered as the road center point corresponding to the road vertical line. The Link data of the road network is integrated with the real vehicle travelling trajectory data by using the above method, and the road center point is determined by using the position data of the points of intersection of the vehicle travelling trajectory and the road vertical line, which can improve the accuracy of the road center point data, thereby helping to improve the recall rate of the road data mining business.

In an implementation, the above method further includes:
connecting road center points corresponding to all road vertical lines of the road unit, to obtain a road centerline of the road unit.

Referring to FIG. 2, for each road vertical line on the same Link, the corresponding road center point can be obtained. The road centerline of the Link can be obtained by connecting the road center points corresponding to all the road vertical lines on the Link.

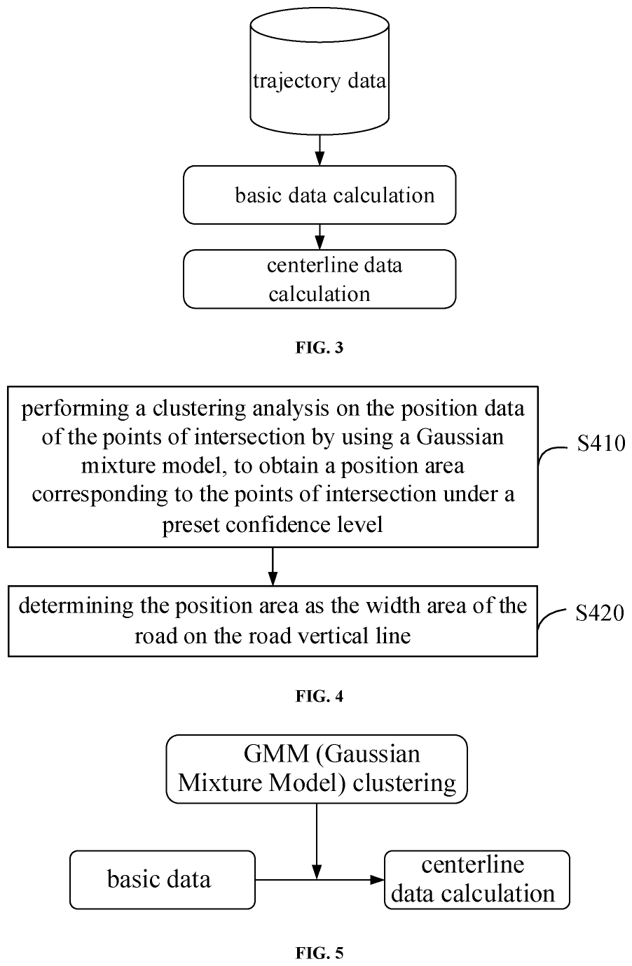

FIG. 3 is a schematic flowchart of centerline data calculation of a road data processing method according to another embodiment of the present disclosure. As shown in FIG. 3, basic data are calculated according to the acquired vehicle travelling trajectory data. Herein, the basic data include the position data of the points of intersection of the vehicle travelling trajectories and the road vertical line. Then, the road centerline data are calculated according to the basic data.

In the embodiment of the present disclosure, the road centerline can be determined according to the integration of the real-time vehicle travelling trajectory data and the Link data of the road network, which can improve the accuracy of the road centerline data, thereby helping to improve the recall rate of the road data mining business.

FIG. 4 is a flowchart of an image processing method according to another embodiment of the present disclosure. As shown in FIG. 4, in an implementation, in S130 in FIG. 1, the determining the width area of the road on the road vertical line according to the position data of the points of intersection, may specifically include:
S410, performing a clustering analysis on the position data of the points of intersection by using a Gaussian mixture model, to obtain a position area corresponding to the points of intersection under a preset confidence level; and
S420, determining the position area as the width area of the road on the road vertical line.

Herein, the Gaussian mixture model (GMM) is to use a Gaussian probability density function (normal distribution curve) to accurately quantify things. It is a model that decomposes things into several models based on the Gaussian probability density function (normal distribution curve).

In an example, the preset confidence level may be set to 90%. According to the normal distribution curve, in the example, the clustering analysis is performed on the points of intersection of the vehicle travelling trajectories and the road vertical line, and more than 90% of the points of intersection may be located in position areas on both sides of the points of intersection of the Link and the road vertical line. For example, more than 90% of the points of intersection may be within 5 meters of the vertical distance from the Link. Only a few 10% of the points of intersection are located far from the Link, and the vertical distances of these points of intersection from the Link may be more than 5 meters. The position areas are the confidence interval corresponding to the confidence level 90%. By performing the clustering analysis on the position data of a large number of points of intersection on a road vertical line, the confidence interval under the preset confidence level can be obtained, that is, the position area corresponding to the points of intersection under the preset confidence level. The position area may be determined as the width area of the road at the position where the road vertical line is located.

Referring to FIG. 2, in an example, in a case where the position coordinates of the point of intersection of the Link and the road vertical line are (5, 0), the width area of the Link at the position where the road vertical line is located may be the area where the line segment whose endpoints are (5, 5) and (5, −5) is located. In another example, in a case where the position coordinates of the point of intersection of the Link and the road vertical line are (10, 0), the width area of the Link at the position where the road vertical line is located may be the area where the line segment whose endpoints are (10, 4.5) and (10, −5.5) is located.

FIG. 5 is a schematic flowchart of centerline data calculation of an image processing method according to another embodiment of the present disclosure. Referring to FIG. 3 and FIG. 5, basic data are calculated by calculation according to the acquired vehicle travelling trajectory data. Herein, the basic data include the position data of the points of intersection of the vehicle travelling trajectories and the road vertical line. Then, MINI clustering is performed on the basic data, and the road centerline data are obtained by calculation.

In the embodiment of the present disclosure, the points of intersection of the vehicle travelling trajectories and the road vertical line are calculated by using a large amount of vehicle travelling trajectory data, and the GMM clustering is performed on the large number of points of intersection, to obtain the road centerline of the link. The above method improves the accuracy of road centerline data and improves the recall rate of the road data mining business.

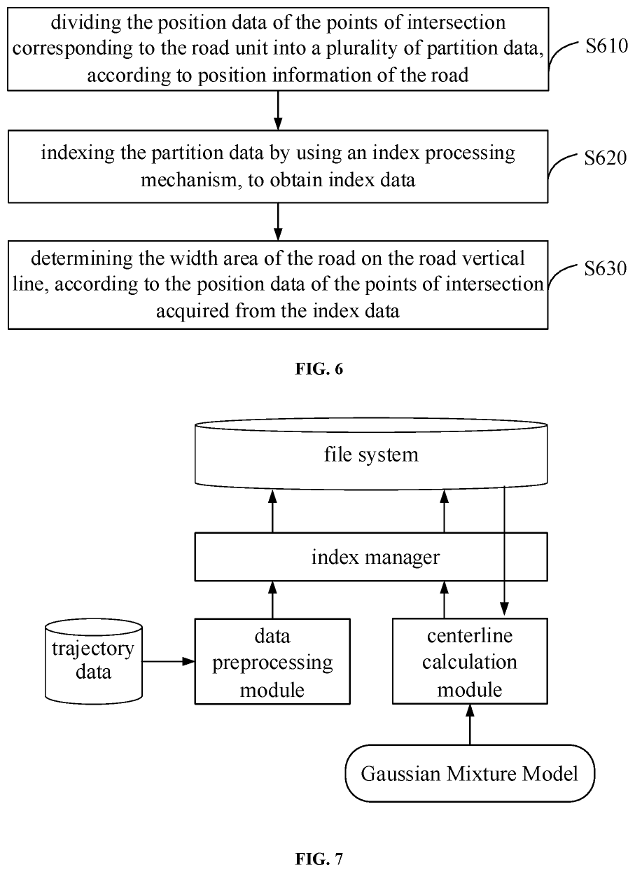

FIG. 6 is a flowchart of an image processing method according to another embodiment of the present disclosure. As shown in FIG. 6, in an implementation, the above method further includes:
S610, dividing the position data of the points of intersection corresponding to the road unit into a plurality of partition data, according to position information of the road;
S620, indexing the partition data by using an index processing mechanism, to obtain index data; and
S630: determining the width area of the road on the road vertical line, according to the position data of the points of intersection acquired from the index data.

In an example, S610 to S630 may be executed after S120 is executed. In S610 to S630, the position data of the points of intersection are indexed, and data can be quickly acquired from the indexed data, thereby improving system performance. Finally, S140 is executed to obtain the road center point corresponding to the road vertical line.

In the general architecture of road attribute mining in related technologies, hadoop-MR (Map Reduce) is used to calculate the road attributes in a specified area in batches offline. Herein, the hadoop-MR refers to a computing framework for distributed systems. After the road attributes are obtained by calculation, all results are stored in a distributed file system, such as a Hadoop Distributed File System (HDFS) or an Andrew File System (AFS), etc. However, the existing distributed file systems do not support fine-grained query of data, and usually require a method of global traversal of the entire dataset file for processing. For example, in the case of only needing to query the latest centerline data of a certain road, it is also necessary to submit a query task in the entire specified area to obtain the centerline data, and then use the traversal search method to query. Obviously, this method reduces the timeliness of fine-grained query of road attributes.

In order to realize the fine-grained query of data, an embodiment of the present disclosure provides a road attribute mining framework. By adding an index manager mechanism, a new data partition is established in combination with the characteristics of road spatial data, so as to realize the fast indexing function of the distributed file system. In an implementation, new data structure types may also be provided to support the indexing mechanism. The above method can realize high-performance and fine-grained calculation and query of road centerline data under massive trajectory big data, which can more flexibly and high-timeliness mine changes in road attributes, and promote the high availability of processing trajectory big data.

In the embodiment of the present disclosure, the calculation of the road centerline may be performed in units of Links. If only a small amount of vehicle travelling trajectory data are used, the accuracy of the calculation results cannot be guaranteed. In order to ensure the accuracy of depicting the road centerline, it is necessary to perform GMM clustering processing on a large number of trajectories. In an example, the vehicle travelling trajectory data of the same Link for N consecutive days may be acquired, so as to cluster the data of the same link. Herein, the value of N can be N>15. A specified area for data processing can be set on a map, for example, the specified area can be set as “part of the geographical areas of the whole country”. There is a large amount of data on the daily vehicle travelling trajectories in the whole country, and the amount of data may be at a TB (terabyte) level. The existing databases have a small capacity and may not be able to support the storage and high-performance query of massive vehicle travelling trajectory data for multiple consecutive days.

To solve such problems, the embodiments of the present disclosure provide a new data storage method based on the characteristics of geospatial information. A specified area and surrounding partial areas are divided into a series of grid areas of rectangles with preset sizes. Herein, the grid area is also called as a picture frame. For example, in a case where the specified area is a “geographic area within the whole country”, the whole country and surrounding partial areas can be divided into a series of square-sized grid areas with a side length of 20 km, and respective grid areas are assigned a series of partition numbers, to achieve nationwide division. In an example, data for each grid area of the whole country may be saved to a file system by taking the date and partition number as a file name. For example, if the date is 20210101 and the partition number is 123, the file name can be “20210101_123”. By dividing the position data of the points of intersection corresponding to the road unit into a plurality of partition data in the above manner, the day-level basic data can be stored in the file system in the form of picture frame division. The file system usually has a large capacity. By using the file system directly, the problem that the database cannot store national trajectory basic data for multiple days can be solved.

Since the file system does not support fine-grained query of data, in the embodiments of the present disclosure, the index processing mechanism is used to index partition data, to obtain index data. The position data of the points of intersection acquired from the index data can improve the timeliness of data query.

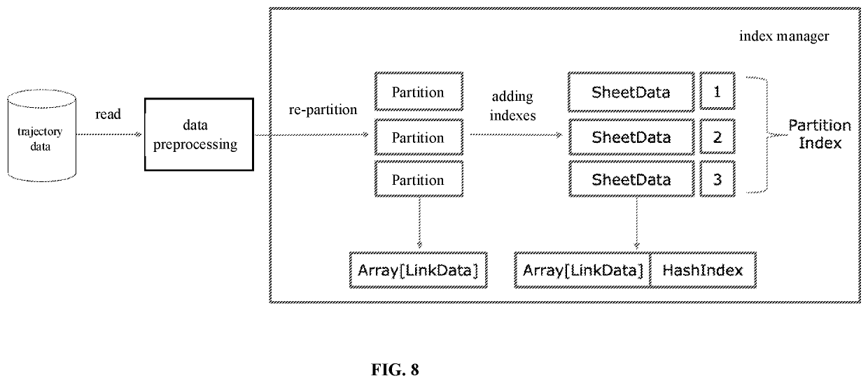

FIG. 7 is a schematic flowchart of centerline data calculation of an image processing method according to another embodiment of the present disclosure. As shown in FIG. 7, a data preprocessing module performs preprocessing on original vehicle travelling trajectory data. The preprocessing may include: calculating the points of intersection of vehicle travelling trajectories and a road vertical line, and dividing the position data of the points of intersection corresponding to the road unit into multiple partition data. An index manager is introduced in the embodiments of the present disclosure, which is used to index the data inside the partition, and can perform index management operations such as addition, deletion, persistence, etc. Referring to FIG. 7, the original vehicle travelling trajectory data are divided into multiple partition data after data preprocessing. The multiple partition data are then entered into the index manager, and the basic data in each partition are indexed in the index manager, to obtain index data. The index data are then stored in the file system. In a case where a centerline is calculated by using the Gaussian mixture model, the position data of the points of intersection of each road vertical line of each Link in each partition data is searched for from the file system through the index manager. The process of searching for data may include: in the first operation, a centerline calculation module first accesses the index manager; in the second operation, the centerline calculation module searches through the index manager for the position of the data required for the calculation in the file system; and in the third operation, the file system returns the data required for the calculation to the centerline calculation module.

The embodiments of the present disclosure solve the problem of timeliness of fine-grained query and improve the system performance, by dividing the specified range into multiple picture frame partitions to reduce the data volume size of each partition, and cooperating with the use of the index processing mechanism to acquire data quickly. In an example, in a case of querying for the attribute data of a certain road centerline, the one-time processing range can be extended to the range that can process data in recent months, and the accuracy of centerline data calculation can be improved by increasing the amount of data, thereby improving the recall rate of the business strategy.

In an implementation, the indexing the partition data by using the index processing mechanism, to obtain the index data, includes:
indexing the partition data by taking an identification of the road unit and a subscript corresponding to the road unit in the partition data as a key-value pair.

FIG. 8 is a schematic diagram of an index manager of an image processing method according to another embodiment of the present disclosure. As shown in FIG. 8, in order to meet the needs of indexing the partition data, optionally, the basic data can be formatted as LinkData type in each partition (Partition). In an example, the data format of the LinkData is: [Linkid, x, y, t, . . . ]. The LinkData data may include point of intersection information of multiple points of intersection in the Link. Herein, Linkid represents the identification of the Link; x represents the latitude coordinate of the point of intersection; y represents the longitude coordinate of the point of intersection; and t represents the time corresponding to the trajectory point, that is, the time when the trajectory point is generated. The entire partition data are saved in the form of Array[LinkData]. Herein, Array represents an array. An element in the array is used to store the data corresponding to a Link.

In an example, in order to improve the performance of querying Link attribute data, the Linkid of each LinkData can be taken as a Key value, the Array subscript corresponding to the LinkData can be taken as a value, and a key-value pair can be composed of the Key and the value. Hash indexes are established inside the partition, to complete the indexing process of the data inside the partition. Referring to FIG. 8, the data set inside the entire partition is stored in the file system in the format of SheetData[HashIndex, Array[LinkData]] in the above manner, so as to complete the indexing of the partition data. Herein, SheetData represents the format of the index data; and HashIndex represents the hash index.

In the above example, the data can be queried through a Hash index function. The input of the Hash index function is the Key value, that is, the Linkid of each LinkData; and the output thereof is the value, that is, the Array subscript corresponding to the LinkData. When it is necessary to query the latest road centerline data of a certain Link, first, partition data corresponding to N consecutive days are read through the partition where the Link is located, and then, the Linkid corresponding to the Link is input into the Hash index function by using the Hash index function inside each partition, so that the Array subscript corresponding to the LinkData can be obtained. Through the above method, the required data can be quickly acquired.

In the embodiment of the present disclosure, through the HashIndex inside each partition, all basic data of the Link can be quickly acquired with the time complexity of O(1), and then the GMM model can be called to calculate the road centerline data. This process can realize minute-level query. Through Hash indexing, the query speed is improved, and the problem of low query performance is solved, enabling the business to support minute-level road centerline query, so that real road attributes and their changes can quickly and accurately described in map products.

In the road attribute mining architecture of the embodiment of the present disclosure, by establishing the index processing mechanism and modifying the data storage type, the retrieval performance of fine-grained data query is improved.

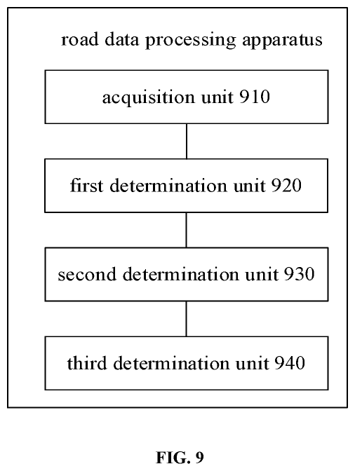

FIG. 9 is a schematic diagram of a road data processing apparatus according to an embodiment of the present disclosure. Referring to FIG. 9, the road data processing apparatus includes:
an acquisition unit 910 configured for acquiring vehicle travelling trajectories of a road and a corresponding road unit in a road network;
a first determination unit 920 configured for establishing a road vertical line for the road unit, and determining points of intersection of the vehicle travelling trajectories and the road vertical line;
a second determination unit 930 configured for determining a width area of the road on the road vertical line according to position data of the points of intersection; and
a third determination unit 940 configured for determining a midpoint of the width area as a road center point corresponding to the road vertical line.

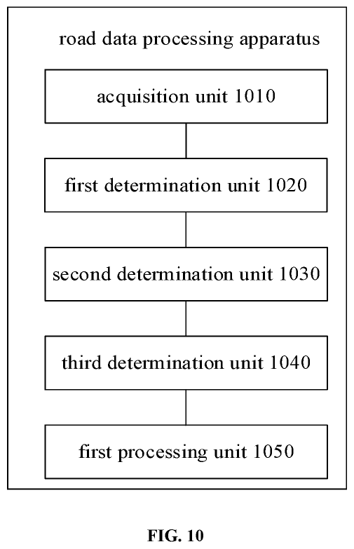

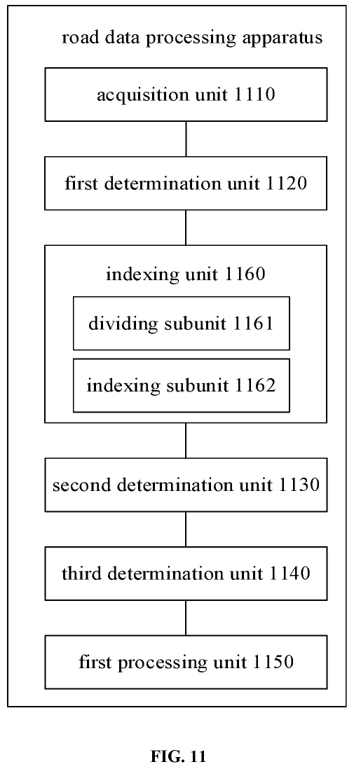

FIG. 10 is a schematic diagram of a road data processing apparatus according to another embodiment of the present disclosure. Referring to FIG. 10, in an implementation, the above-mentioned apparatus further includes a first processing unit 1050 configured for:
connecting road center points corresponding to all road vertical lines of the road unit, to obtain a road centerline of the road unit.

In an implementation, the second determination unit 1030 is configured for:
performing a clustering analysis on the position data of the points of intersection by using a Gaussian mixture model, to obtain a position area corresponding to the points of intersection under a preset confidence level; and
determining the position area as the width area of the road on the road vertical line.

FIG. 11 is a schematic diagram of a road data processing apparatus according to another embodiment of the present disclosure. Referring to FIG. 11, the above-mentioned apparatus further includes an indexing unit 1160.

The indexing unit 1160 includes: a dividing subunit 1161 configured for dividing the position data of the points of intersection corresponding to the road unit into a plurality of partition data, according to position information of the road; and an indexing subunit 1162 configured for indexing the partition data by using an index processing mechanism, to obtain index data; and
the second determination unit 1130 is further configured for determining the width area of the road on the road vertical line, according to the position data of the points of intersection acquired from the index data.

In an implementation, the indexing subunit 1162 is configured for:
indexing the partition data by taking an identification of the road unit and a subscript corresponding to the road unit in the partition data as a key-value pair.

For the functions of respective units in the road data processing apparatus of the embodiments of the present disclosure, reference may be made to the corresponding descriptions in the above road data processing methods, and details are not repeated here.

According to embodiments of the present disclosure, the present disclosure also provides an electronic device, a readable storage medium, and a computer program product.

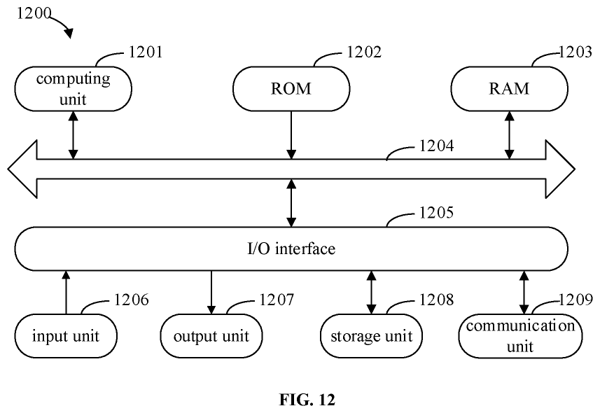

FIG. 12 shows a schematic block diagram of an example electronic device 1200 that may be configured to implement embodiments of the present disclosure. The electronic device is intended to represent various forms of digital computers, such as laptop computers, desktop computers, workstations, personal digital assistants, servers, blade servers, mainframe computers, and other suitable computers. The electronic device may also represent various forms of mobile devices, such as a personal digital assistant, a cellular telephone, a smart phone, a wearable device, and other similar computing devices. The components shown herein, their connections and relationships, and their functions are by way of example only and are not intended to limit the implementations of the present disclosure described and/or claimed herein.

As shown in FIG. 12, the electronic device 1200 includes a computing unit 1201 that may perform various suitable actions and processes in accordance with computer programs stored in a read only memory (ROM) 1202 or computer programs loaded from a storage unit 1208 into a random access memory (RAM) 1203. In the RAM 1203, various programs and data required for the operation of the electronic device 1200 may also be stored. The computing unit 1201, the ROM 1202, and the RAM 1203 are connected to each other through a bus 1204. An input/output (I/O) interface 1205 is also connected to the bus 1204.

A plurality of components in the electronic device 1200 are connected to the I/O interface 1205, including: an input unit 1206, such as a keyboard, a mouse, etc.; an output unit 1207, such as various types of displays, speakers, etc.; a storage unit 1208, such as a magnetic disk, an optical disk, etc.; and a communication unit 1209, such as a network card, a modem, a wireless communication transceiver, etc. The communication unit 1209 allows the electronic device 1200 to exchange information/data with other devices over a computer network, such as the Internet, and/or various telecommunications networks.

The computing unit 1201 may be various general purpose and/or special purpose processing assemblies having processing and computing capabilities. Some examples of the computing unit 1201 include, but are not limited to, a central processing unit (CPU), a graphics processing unit (GPU), various specialized artificial information (AI) computing chips, various computing units running machine learning model algorithms, a digital signal processor (DSP), and any suitable processor, controller, microcontroller, etc. The computing unit 1201 performs various methods and processing procedures described above, such as the road data processing method or the image processing method. For example, in some embodiments, the road data processing method or the image processing method may be implemented as computer software programs that are physically contained in a machine-readable medium, such as the storage unit 1208. In some embodiments, some or all of the computer programs may be loaded into and/or installed on the electronic device 1200 via the ROM 1202 and/or the communication unit 1209. In a case where the computer programs are loaded into the RAM 1203 and executed by the computing unit 1201, one or more of operations of the above road data processing method or image processing method may be performed. Alternatively, in other embodiments, the computing unit 1201 may be configured to perform the road data processing method or the image processing method in any other suitable manner (e.g., by means of a firmware).

Various implementations of the systems and techniques described herein above may be implemented in a digital electronic circuit system, an integrated circuit system, a field programmable gate array (FPGA), an application specific integrated circuit (ASIC), an application specific standard product (ASSP), a system on a chip (SOC), a load programmable logic device (CPLD), a computer hardware, a firmware, a software, and/or a combination thereof. These various implementations may include an implementation in one or more computer programs, which can be executed and/or interpreted on a programmable system including at least one programmable processor; the programmable processor may be a dedicated or general-purpose programmable processor and capable of receiving and transmitting data and instructions from and to a storage system, at least one input device, and at least one output device.

The program codes for implementing the road data processing method or the image processing method of the present disclosure may be written in any combination of one or more programming languages. These program codes may be provided to a processor or controller of a general purpose computer, a special purpose computer, or other programmable data processing apparatus such that the program codes, when executed by the processor or controller, enable the functions/operations specified in the flowchart and/or the block diagram to be implemented. The program codes may be executed entirely on a machine, partly on a machine, partly on a machine as a stand-alone software package and partly on a remote machine, or entirely on a remote machine or server.

In the context of the present disclosure, the machine-readable medium may be a tangible medium that may contain or store programs for using by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination thereof. More specific examples of the machine-readable storage medium may include one or more wires-based electrical connection, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination thereof.

In order to provide an interaction with a user, the system and technology described here may be implemented on a computer having: a display device (e. g., a cathode ray tube (CRT) or a liquid crystal display (LCD) monitor) for displaying information to the user; and a keyboard and a pointing device (e. g., a mouse or a trackball), through which the user can provide an input to the computer. Other kinds of devices can also provide an interaction with the user. For example, a feedback provided to the user may be any form of sensory feedback (e.g., visual feedback, auditory feedback, or tactile feedback); and an input from the user may be received in any form, including an acoustic input, a voice input or a tactile input.

The systems and techniques described herein may be implemented in a computing system (e.g., as a data server) that includes a background component, or a computing system (e.g., an application server) that includes a middleware component, or a computing system (e.g., a user computer having a graphical user interface or a web browser through which a user may interact with implementations of the systems and techniques described herein) that includes a front-end component, or a computing system that includes any combination of such background components, middleware components, or front-end components. The components of the system may be connected to each other through a digital data communication in any form or medium (e.g., a communication network). Examples of the communication network may include a local area network (LAN), a wide area network (WAN), and the Internet.

The computer system may include a client and a server. The client and the server are typically remote from each other and typically interact via the communication network. The relationship of the client and the server is generated by computer programs running on respective computers and having a client-server relationship with each other.

It should be understood that the operations can be reordered, added or deleted by using the various flows illustrated above. For example, the various operations described in the present disclosure may be performed concurrently, sequentially or in a different order, so long as the desired results of the technical solutions provided in the present disclosure can be achieved, and there is no limitation herein.

The above-described specific implementations do not limit the scope of the present disclosure. It will be apparent to those skilled in the art that various modifications, combinations, sub-combinations, and substitutions are possible, depending on design requirements and other factors. Any modifications, equivalent substitutions, and improvements within the spirit and principles of the present disclosure are intended to be included within the scope of the present disclosure.

1. A road data processing method, comprising:
acquiring vehicle travelling trajectories of a road and a corresponding road unit in a road network;
establishing a road vertical line for the road unit, and determining points of intersection of the vehicle travelling trajectories and the road vertical line;
determining a width area of the road on the road vertical line according to position data of the points of intersection; and
determining a midpoint of the width area as a road center point corresponding to the road vertical line.

2. The method of claim 1, further comprising:
connecting road center points corresponding to all road vertical lines of the road unit, to obtain a road centerline of the road unit.

3. The method of claim 1, wherein the determining the width area of the road on the road vertical line according to the position data of the points of intersection, comprises:
performing a clustering analysis on the position data of the points of intersection by using a Gaussian mixture model, to obtain a position area corresponding to the points of intersection under a preset confidence level; and
determining the position area as the width area of the road on the road vertical line.

4. The method of claim 1, further comprising:
dividing the position data of the points of intersection corresponding to the road unit into a plurality of partition data, according to position information of the road;
indexing the partition data by using an index processing mechanism, to obtain index data; and
determining the width area of the road on the road vertical line, according to the position data of the points of intersection acquired from the index data.

5. The method of claim 4, wherein the indexing the partition data by using the index processing mechanism, to obtain the index data, comprises:
indexing the partition data by taking an identification of the road unit and a subscript corresponding to the road unit in the partition data as a key-value pair.

6-10. (canceled)

11. An electronic device, comprising:
at least one processor; and
a memory communicatively connected with the at least one processor, wherein the memory stores instructions executable by the at least one processor, and the instructions, when executed by the at least one processor, enable the at least one processor to perform operations of:
acquiring vehicle travelling trajectories of a road and a corresponding road unit in a road network;
establishing a road vertical line for the road unit, and determining points of intersection of the vehicle travelling trajectories and the road vertical line;
determining a width area of the road on the road vertical line according to position data of the points of intersection; and
determining a midpoint of the width area as a road center point corresponding to the road vertical line.

12. A non-transitory computer-readable storage medium storing computer instructions, wherein the computer instructions, when executed by a computer, cause the computer to perform operations of:
acquiring vehicle travelling trajectories of a road and a corresponding road unit in a road network;
establishing a road vertical line for the road unit, and determining points of intersection of the vehicle travelling trajectories and the road vertical line;
determining a width area of the road on the road vertical line according to position data of the points of intersection; and
determining a midpoint of the width area as a road center point corresponding to the road vertical line.

13. (canceled)

14. The method of claim 2, wherein the determining the width area of the road on the road vertical line according to the position data of the points of intersection, comprises:
performing a clustering analysis on the position data of the points of intersection by using a Gaussian mixture model, to obtain a position area corresponding to the points of intersection under a preset confidence level; and
determining the position area as the width area of the road on the road vertical line.

15. The method of claim 2, further comprising:
dividing the position data of the points of intersection corresponding to the road unit into a plurality of partition data, according to position information of the road;
indexing the partition data by using an index processing mechanism, to obtain index data; and
determining the width area of the road on the road vertical line, according to the position data of the points of intersection acquired from the index data.

16. The electronic device of claim 11, wherein the instructions, when executed by the at least one processor, enable the at least one processor to further perform an operation of:
connecting road center points corresponding to all road vertical lines of the road unit, to obtain a road centerline of the road unit.

17. The electronic device of claim 11, wherein the determining the width area of the road on the road vertical line according to the position data of the points of intersection, comprises:
performing a clustering analysis on the position data of the points of intersection by using a Gaussian mixture model, to obtain a position area corresponding to the points of intersection under a preset confidence level; and
determining the position area as the width area of the road on the road vertical line.

18. The electronic device of claim 11, wherein the instructions, when executed by the at least one processor, enable the at least one processor to further perform operations of:
dividing the position data of the points of intersection corresponding to the road unit into a plurality of partition data, according to position information of the road;
indexing the partition data by using an index processing mechanism, to obtain index data; and
determining the width area of the road on the road vertical line, according to the position data of the points of intersection acquired from the index data.

19. The electronic device of claim 18, wherein the indexing the partition data by using the index processing mechanism, to obtain the index data, comprises:
indexing the partition data by taking an identification of the road unit and a subscript corresponding to the road unit in the partition data as a key-value pair.

20. The electronic device of claim 16, wherein the determining the width area of the road on the road vertical line according to the position data of the points of intersection, comprises:
performing a clustering analysis on the position data of the points of intersection by using a Gaussian mixture model, to obtain a position area corresponding to the points of intersection under a preset confidence level; and
determining the position area as the width area of the road on the road vertical line.

21. The electronic device of claim 16, wherein the instructions, when executed by the at least one processor, enable the at least one processor to further perform an operation of:
dividing the position data of the points of intersection corresponding to the road unit into a plurality of partition data, according to position information of the road;
indexing the partition data by using an index processing mechanism, to obtain index data; and
determining the width area of the road on the road vertical line, according to the position data of the points of intersection acquired from the index data.

22. The non-transitory computer-readable storage medium of claim 12, wherein the computer instructions, when executed by a computer, cause the computer to perform an operation of:
connecting road center points corresponding to all road vertical lines of the road unit, to obtain a road centerline of the road unit.

23. The non-transitory computer-readable storage medium of claim 12, wherein the determining the width area of the road on the road vertical line according to the position data of the points of intersection, comprises:
performing a clustering analysis on the position data of the points of intersection by using a Gaussian mixture model, to obtain a position area corresponding to the points of intersection under a preset confidence level; and
determining the position area as the width area of the road on the road vertical line.

24. The non-transitory computer-readable storage medium of claim 12, wherein the computer instructions, when executed by a computer, cause the computer to perform operations of:
dividing the position data of the points of intersection corresponding to the road unit into a plurality of partition data, according to position information of the road;
indexing the partition data by using an index processing mechanism, to obtain index data; and
determining the width area of the road on the road vertical line, according to the position data of the points of intersection acquired from the index data.

25. The non-transitory computer-readable storage medium of claim 24, wherein the indexing the partition data by using the index processing mechanism, to obtain the index data, comprises:
indexing the partition data by taking an identification of the road unit and a subscript corresponding to the road unit in the partition data as a key-value pair.

26. The non-transitory computer-readable storage medium of claim 22, wherein the determining the width area of the road on the road vertical line according to the position data of the points of intersection, comprises:
performing a clustering analysis on the position data of the points of intersection by using a Gaussian mixture model, to obtain a position area corresponding to the points of intersection under a preset confidence level; and
determining the position area as the width area of the road on the road vertical line.
